(19) United States
(12) Patent Application Publication
(10) Pub. No.: US 2024/0235932 A9
(43) Pub. Date: Jul. 11, 2024

(54) METHOD FOR COMMISSIONING A DOOR SYSTEM

(71) Applicants: DORMAKABA DEUTSCHLAND GMBH, Ennepetal (DE); DORMAKABA INTERNATIONAL HOLDING GMBH, Ennepetal (DE); DORMAKABA SCHWEIZ AG, Rümlang (CH); DORMAKABA EAD GMBH, Villingen-Schwennigen (DE); DORMAKABA ESPAÑA S.A.U., Madrid (ES)

(72) Inventors: Kai OBERSTE-UFER, Ennepetal (DE); Christian RAPPEL, Wetzikon (CH); Thomas VOGLER, Ennepetal (DE); Sven BUSCH, Ennepetal (DE); Ingo HALDER, Ennepetal (DE); Bernd GEHRMANN, Ennepetal (DE); Andrzej DUDZINSKI, Ennepetal (DE); Chandra Prakash GUPTA, Ennepetal (DE); Oliver BORCHMANN, Ennepetal (DE); Frank LORENZ, Rümlang (CH); Martin WOLF, Bonn (DE); Alexander BRADFISCH, Ennepetal (DE); Stephan GIERNICH, Bonn (DE); Pedro GUERRA, Madrid (ES)

(21) Appl. No.: 18/547,464

(22) PCT Filed: Aug. 19, 2021
(86) PCT No.: PCT/EP2021/073068

§ 371 Date: Aug. 22, 2023

(30) Foreign Application Priority Data
Feb. 24, 2021 (EP) 21382158.0

(51) Int. Cl. H04L 41/0806; G07C 9/00; H04L 12/40; H04L 41/0866; H04W 8/22

(52) U.S. Cl. CPC H04L 41/0806; G07C 9/00944; H04L 12/40032; H04L 41/0866; H04W 8/22

(57) ABSTRACT

A method for commissioning a door system with the door system having door components, with at least one door component being designed as a control unit, with the method including the following steps:
storing an electronic configuration of the door system in the control unit and/or a mobile terminal, and
carrying out at least one commissioning step by the electronic configuration.

### CROSS-REFERENCE TO RELATED APPLICATIONS

This application is a 35 U.S.C. § 371 National Stage patent application of PCT/EP2021/073068, filed on 19 Aug. 2021, which claims the benefit of European patent application 21382158.0, filed on 24 Feb. 2021, the disclosures of which are incorporated herein by reference in their entirety.

### TECHNICAL FIELD

The disclosure relates to a method for commissioning a door system.

### BACKGROUND

Door systems can comprise different door components that influence the function of a door. For example, a door system can comprise door drives, escape route security systems and/or access control devices. According to the prior art, the door drives, the escape route security systems and/or the access control devices are each installed and put into operation separately. Different trades are usually involved here. The trades each carry out interconnections and parameterizations separately. For this reason, the door components are often not adjusted to each other or installed incorrectly, so that the quality of the commissioning cannot be guaranteed. Therefore, there may be problems with the security of the door system, malfunctions or repairs may be required.

### SUMMARY

The disclosure provides a method for commissioning a door system, a door system, a door arrangement and/or a computer program product that changes the commissioning in such manner that the security of the door system is increased during operation, malfunctions are reduced and/or the commissioning is possible without repairs.

This is achieved by providing a method having the features of claim 1. Advantageous further developments of the method are specified in the dependent claims, the description and in the figures. Features and details that are described in connection with the method according to the disclosure thereby also apply in connection with a computer program product according to the disclosure and/or a door system according to the disclosure and/or a door arrangement according to the disclosure and vice versa. In particular, placed under protection are a computer program product with which a method according to the disclosure, in particular a method according to one of claims 1 to 15, can be carried out, and/or a door system or a door arrangement, with which a method according to the disclosure, in particular a method according to one of the claims 1 to 15, can be carried out. The door system according to the disclosure and the door arrangement according to the disclosure comprise at least one electronic memory as a computer-readable medium on which the computer program according to the disclosure is stored in an executable manner. The features mentioned in the description and in the claims can thereby each be essential to the disclosure individually or in combination. The description additionally characterizes and specifies the disclosure, in particular in connection with the figures.

The method according to the disclosure is used to commission a door system. The door system comprises a plurality of door components. At least one door component is designed as a control unit. The method according to the disclosure comprises the following steps:
a. storing an electronic configuration of the door system in the control unit and/or on a mobile terminal,
b. carrying out a commissioning step by means of the electronic configuration.

Due to the fact that the door system with a plurality of door components is at least partially put into operation by way of an electronic configuration, adjustment errors are avoided and/or faulty installations are detected. This increases the security of the door system. Here, the electronic configuration comprises information relating to the plurality of door components. Information for the door system is preferably combined in a common electronic configuration.

The electronic configuration is designed in particular as at least one electronic file. The electronic configuration is preferably designed as an electronic template. It may be that the configuration comprises an electronic file with information on a plurality of door components. Alternatively, the electronic configuration may comprise electronic files for individual door components or door component groups.

In particular, a plurality of door components that are designed to be arranged on at least one door are referred to as a door system.

At least one of the door components serves in particular to change the door state. The change of the door state can e.g. correspond to opening the door, closing the door, unlocking the door, locking the door, providing a state for manually unlocking and/or locking, opening and/or closing the door.

For example, a door component can be designed as a motorized door drive. The motorized door drive can effect a motorized opening and/or closing of the door. In another example, a door component may be designed as an electrically actuatable locking element. The electrically actuatable locking element can effect unlocking and/or locking of the door. The locking element can, for example, be designed as a motor lock, as a motorized lock cylinder or an electromagnetic door lock. In a further example, a door component can be designed to transfer the door into a manually unlockable state. A door component that can transfer the door into a manually unlockable state is referred to below as an unlocking element. For example, the door component can be designed as an electric door opener. The electric door opener can assume a state in which manual actuation of the door unlocks and simultaneously opens the door, while in another state of the door opener, manual actuation of the door and thus unlocking and opening of the door is prevented. Other examples of providing a state for manually unlocking a door can be seen in an electromechanical lock cylinder and/or an electromechanical fitting.

The door system may comprise at least one door component that generates a signal for changing the door state. A door component of this type is referred to as a signal transmitter. In particular, the signal can cause another door component, e.g. the motorized door drive, the locking element and/or the unlocking element to change the door state. For example, the signal transmitter can be designed as a sensor that detects a person approaching the door. In another example, the signal transmitter can be designed as a manual button or key button, which a user actuates to transmit their opening request to the door system. In a further example, the signal transmitter can be designed as a hazard detector, for example a smoke detector. In a further example, the signal transmitter can be designed as an authentication device. The authentication device verifies an authorization of a user to go through the door. If the user is authorized, the authentication device sends a corresponding signal to another door component, e.g. to a locking device or an unlocking device that allows access.

The door system can be designed to receive an access attribute of an authorized user. For this purpose, the door system can comprise a detection unit as a door component. The detection unit can be designed as a transmitting and receiving unit, as a biometric sensor, as a keypad for inputting a PIN and/or as a contact element for making electrical contact with an in particular electronic key. The access attribute can be designed as a credential or a biometric feature of the user. The credential can e.g. comprise an access code and/or a time window for access authorization. It may be that the door system e.g. a reader with a transmitting and receiving unit is designed for wirelessly receiving an access attribute, in particular credentials. The transmitting and receiving unit can be designed to communicate with a mobile terminal, in particular a mobile telephone or a card, by near-field communication, in particular RFID, NFC or Bluetooth Low Energy. For example, a reader can be regarded as a detection unit.

An access control device can comprise an authentication device and/or a detection unit.

It may be that a plurality of functions are implemented in the same door component. For example, an electromechanical fitting can comprise a coupling element that allows the manual unlocking of the door in an engaged state. At the same time, the electromechanical fitting comprises a detection unit, in particular a transmitting and receiving unit for wirelessly receiving a credential. In addition, the electromechanical fitting can comprise a processor and a memory, with which the credential is evaluated and a decision is made regarding access. Thus, the electromechanical fitting acts as an authentication device.

The door system can be designed to be arranged on a door. A door system preferably comprises all door components intended to be arranged on a door. It may be that the door system is designed for single-leaf or double-leaf doors.

The door system can be designed to be arranged on a plurality of doors. For example, the door system can comprise door components for up to four doors. It may be that the doors are sometimes designed with two leaves. A door system preferably comprises all door components intended to be arranged on the plurality of doors.

It is conceivable that the door components interact functionally for at least a part of the plurality of doors, in particular form an interlock.

The control unit preferably comprises an electronic processor. The control unit preferably comprises at least one electronic memory. The electronic configuration can be stored in the memory.

In particular, commissioning refers to the steps that take place after the door components have been attached to the door and the door components have been wired to the door, before the door system can begin to be operated.

It can be provided that the method is partially carried out by means of the mobile terminal. The mobile terminal is used in particular by the installer during commissioning. The mobile terminal can be e.g. a mobile telephone or a tablet. The mobile terminal can comprise a screen and/or a loudspeaker as an output unit.

It may be that the control unit comprises a transmitting and receiving unit for wireless near-field communication with the mobile terminal. The wireless near-field communication can be e.g. Bluetooth Low Energy (BLE), NFC, RFID or WIFI.

Each door system preferably comprises only a single control unit in which the electronic configuration is stored.

It may be that a computing unit is provided. The computing unit can comprise at least one electronic memory. The electronic memory can comprise at least one database. It may be that the electronic configuration can be loaded from the computing unit into the control unit. The computing unit can be designed in particular as a cloud.

The computing unit can be designed e.g. as a cloud and/or as a cloud and a computing device connected to the cloud, e.g. a personal computer. The computing unit can be connected or connectable to a mobile terminal, e.g. a mobile telephone or a tablet. In this case, the computing unit and the mobile terminal can be connectable to one another, for example via a telecommunications connection and/or via the Internet.

The door system preferably comprises different door component types. A door component type is defined in particular by the function that the door component type has in relation to the door on which the door component corresponding to the door component type is to be installed. The function can comprise the described change of a door state and/or the generation of a signal for changing the door state.

Furthermore, the door component type can contain properties of the door or can be adjusted to the property of the door. The properties of the door can correspond to functional properties, e.g. sliding doors, swing leaf doors and revolving doors. The properties of the door can correspond to the design as a full leaf or as a tubular frame door. The properties of the door can correspond to the spatial dimensions and/or the weight of the door. For example, the power of the door drive can be adapted to the weight of the door. Furthermore, the door component type can contain functional properties of the door component type itself. Examples of the functional properties can comprise e.g. “suitable for the escape route”, “for a fire protection door”, “self-locking”, “self-closing”.

Examples of different door component types can be e.g. a “self-locking anti-panic lock with motor for full leaf doors” or “self-closing swing leaf door drive for use on normal doors up to 1100 mm wide or 160 kg weight”.

It may be that door component types differ additionally or alternatively by the type and/or the arrangement of the electrical connection to at least one other door component type. For example, the door component types can differ in terms of the interface to which a connection is to be established to which other door component. Thus, the door component types e.g. differ by an assignment of connection terminals. Additionally or alternatively, the door component types differ in the type of electronic integration into the door system. For example, the door component types can differ as to whether a connection to at least one further door component takes place via a bus system, and possibly via which bus system.

It may be that the control unit and at least one of the further door components of the door system are in an information technology connection with one another. The control unit and the further door components can thus exchange electronic messages. Preferably, the control unit is in the information technology connection with a plurality of the other door components of the door system. The control unit is particularly preferably in an information technology connection with all other door components of the door system.

For example, the at least one further door component and the control unit can be connected to one another via a first bus system. A connection to a bus system is understood below to mean a direct connection, so that a component connected to the bus system is to be regarded as a participant of the bus system with its own bus address. The first bus system can be designed as a field bus, in particular as a CAN bus.

It can be provided that at least a part of the door components are connected to the control unit via an in particular further bus system. The in particular further bus system can be configured as a field bus, in particular an RS 485 bus. The at least one door component, which is connected to the control unit via the further bus system, can in particular be a detection unit. Further detection units are preferably connected to the further bus system.

It is preferably provided that the electronic configuration comprises a list of components. The electronic configuration can comprise a list of components of at least a part of the provided door components of the door system. The list of components preferably comprises at least the door components of the door system, which are in an information technology connection with the control unit. The list of components particularly preferably comprises all door components of the door system.

Additionally or alternatively, it may be that the electronic configuration comprises a list of components for at least part of the provided door component types of the door system. The list of components preferably comprises at least the door component types of the door system that have an information technology connection with the control unit. The list of components particularly preferably comprises all door component types of the door system.

It may be that the list of components also comprises the provided position of a provided door component and/or a provided door component type on the at least one door on which the door system is to be arranged. It is therefore preferably provided that the control unit has, by means of the list of components, at least partial knowledge of how the door system to be installed is configured.

It can be provided that the control unit has knowledge of the installed door component types or the installed door components that are arranged on the at least one door of the door system. It can be provided that the control unit has knowledge of the installed door component types or the installed door components of the door system, which are in an information technology connection with the control unit, in particular via the first or the further bus system.

It can be provided that the control unit has knowledge of all installed door component types or the installed door components of the door system. It may be that all installed door components of the door system are in an information technology connection with the control unit. Alternatively, it may be that installed door components, to which a further door component is in turn connected, report the further door component to the control unit, and/or an installer reports further door components to the control unit, in particular via the mobile terminal.

It is preferably provided that the control unit and/or the mobile terminal compare the list of components with the door components actually installed and/or the door component types actually installed. If the comparison takes place in the mobile terminal, the control unit first reports to the mobile terminal the door components actually installed and/or the door component types actually installed.

If the comparison shows that the list of components corresponds to the door components actually installed and/or the door component types actually installed, then the control unit and/or the mobile terminal continue with the commissioning method, in particular automatically, as intended.

If the comparison shows that the list of components does not correspond to the door components actually installed and/or the door component types actually installed, it is preferably provided that the commissioning method is interrupted by the control unit and/or the mobile terminal. It may be that the result of the comparison is displayed to the installer on a mobile terminal.

It can be provided that a specification is stored electronically as to how the commissioning method is to be continued if the list of components deviates from the installed door component types or the installed door components.

The specification of how to continue the commissioning method can correspond to one of the following options depending on the type of deviation:
the start-up of an operation of the door system is electronically prevented,
the start-up of an operation of the door system takes place with a limited range of door components,
the start-up of an operation of the door system takes place as intended.

As a rule, the start-up of the operation or the continuation of the commissioning method will be electronically prevented. It may be that the start-up of the operation takes place with a limited range of door components and/or functions. For example, during the completion of a building, there are no plans to install or put into operation access control device. It is therefore conceivable that the door system initially goes into operation without an access control device.

The start-up of the operation can take place, for example, if a provided door component is replaced with a door component of the same or higher value.

It may be that the specification is automatically implemented by the control unit and/or the mobile terminal. It may be the case here that the installer is informed of the specification on the mobile terminal.

Alternatively, the specification is displayed to the installer on the mobile terminal and a confirmation is requested by input on the mobile terminal.

In one configuration of the method according to the disclosure, the commissioning of the door system is always interrupted if a deviation is determined by the control unit. In particular, the interruption of the commissioning method is displayed to the installer, e.g. on the mobile terminal.

It can be provided that an alternative configuration is stored on the memory device and/or the mobile terminal if the deviation prevents the commissioning method from being continued. Thus step a. is repeated with an alternative configuration. The alternative configuration can be provided by a database, for example.

It may be that different provided door component assemblies form different door system types in each case. Each door system type is preferably assigned to an electronic configuration, in particular exactly one electronic configuration. A configuration is in each case stored e.g. in the database for each door system type. The alternative configuration can be loaded e.g. from the database into the memory device and/or the mobile terminal.

If the continuation of the commissioning method is prevented by the deviation, it can be provided that a door system type is changed to an alternative door system type that corresponds to the installed door component types or the installed door components, with step a., preferably also step b, being repeated with the electronic configuration of the alternative door system type.

It may be that an electronic configuration system automatically finds in the database the alternative configuration suitable for the door components actually installed and makes it available for storage on the control unit and/or on the mobile terminal. Alternatively, it may be that the electronic configuration system suggests an alternative configuration that suits the door components actually installed and must be confirmed by the installer or a building planner. In a further alternative, the installer or the building planner must independently select the alternative configuration from the database. It is conceivable that the building planner, but not the installer, has the authority to confirm or select the alternative configuration. The electronic configuration system preferably comprises a database in which technical and/or functional properties of a door system type are linked to the door system type. The suitable door system type can be found by means of the configuration system, in particular by filtering on the basis of the technical and/or functional properties.

It is preferably provided that the door components of the door system or the door components which are connected to the control unit in terms of information technology each comprise an identifier. It may be that the identifier is assigned at least once to one of the door components of the door system. For example, the identifier can be a bus address. Alternatively, it is a unique identifier that is assigned once or a unique identifier that is only allocated once per door component type and/or per database.

It can be provided that the method comprises the step that the identifier of the door components is assigned at least partially to the door components or door component types listed in the list of components. At least the door components that have an information technology connection with the control unit are assigned to the door components or door component types listed in the list of components.

It is preferably provided that if only one door component of a door component type is present in the door system, the installed door component is automatically assigned to the door component type. The automatic assignment is carried out in the door arrangement, preferably in the door system, particularly preferably by the control unit and/or the mobile terminal. The automatic assignment can comprise the assignment of the bus address or the in particular unique identifier to the door component type.

Door components preferably occupy positions within a door system. For example, the position can be “on the active leaf” or “on the first door”. Thus, it can be an explicit position. Alternatively, the position can also be a designation, in particular a numbering, of the provided door component within the door system. For example, a designation could read “Door drive 1” for the door drive on the passive leaf door or on door 1. In another example, “door component 1” could be the designation for the door drive on the passive leaf door or on door 1. In all cases, the numbering can be traced back to explicit position information. As a result, an assignment to a position is given indirectly.

Installed door components are preferably arranged at an installation location. For example, the installation location can be the location coordinates or a designation, in particular the designation of a building region, such as e.g. “hotel room door 357” or “front entrance region”.

It may be that an installed door component, in particular the identifier of the door component, is assigned to a provided door component by means of an input on the mobile terminal. This method can be provided in particular if a door system comprises a plurality of door components of the same door component type and/or a plurality of door systems are to be installed. Provided door component is understood to mean in particular a door component listed in the list of components or a door component type or a door component, in particular a control unit, in one of a plurality of door systems.

An installed door component, in particular the identifier of the door component, can be assigned to a provided door component, e.g. by inputting the provided door component on the mobile terminal. For example, at least one, preferably a plurality of, provided door components are displayed on the mobile terminal for input on the mobile terminal. The assignment preferably takes place within the door arrangement. It can be provided that the assignment is stored in the control unit and/or in the computing unit. It is only in rare cases that the input of a provided door component does not also comprise the at least indirect input of a position.

It can be provided that an installed door component, in particular the identifier of the door component, is assigned to a provided door component by inputting an installation location, a door system or a position on the mobile terminal. For example, at least one possible position, at least one possible installation location and/or at least one possible door system of provided door components is displayed on the mobile terminal. For this purpose, possible positions, possible installation locations and/or a possible door system of provided door components, in particular of the same door component type, are preferably displayed on the mobile terminal. The assignment preferably takes place within the door arrangement. It can be provided that the assignment is stored in the control unit and/or in the computing unit.

It can be provided that at least one possible provided door component, a possible installation location, at least one possible door system and/or at least one possible position is displayed to the installer on the mobile terminal for entry.

The installer can confirm the provided door component, installation location, door system or position.

It can be provided that a plurality of possible provided door components, a plurality of possible installation locations, a plurality of possible door systems and/or a plurality of possible positions are displayed to the installer on the mobile terminal for input. The installer can select the provided door component, installation location, door system or position. A plurality of provided door components, a plurality of possible positions, possible installation locations and/or possible door systems can be displayed one after the other or simultaneously on the mobile terminal.

It may be that an installed door component is assigned to a provided door component on the mobile terminal. It can be provided that the mobile terminal sends the assignment to the control unit and/or to the computing unit.

It can be provided that the identifier or the assigned marking of the selected door components is assigned to a provided door component of the door system on the mobile terminal by receiving a user input. This is in particular the case when a plurality of door components of the same door component type are provided in the door system. For this purpose, at least one position of the provided door components or the provided door components is preferably displayed on the mobile terminal, so that the installer can select or confirm the position of the provided door component or the provided door component. A plurality of positions or provided door components can be displayed one after the other or simultaneously on the mobile device. At least the positions of provided door components of the same door component type are preferably displayed on the mobile terminal. It may be that an installed door component, in particular a control unit, is assigned to a door system on the mobile terminal by receiving a user input. In particular, at least one door system or an installation location is displayed to the installer for selection or confirmation.

It can be provided that an installed door component is assigned to an installation location, to a door system and/or to a position on the mobile terminal.

In particular, the installed door components are assigned to the provided door component after the provided door component, the installation location, the door system and/or the position have been input on the mobile terminal.

Alternatively, the control unit and/or the computing unit can assign an installed door component to a provided door component, to an installation location, to a door system and/or to a position. For this purpose, the mobile terminal sends the control unit and/or the computing unit the result of the input in relation to the provided door component, the installation location, the door system or the position.

In order to assign an installed door component to a provided door component, to an installation location, to a door system and/or to a position, the installer can assign an identifier or a marking of the components to a provided door component, to an installation location, to a door system and/or to a position. For this purpose, possible provided door components, possible installation locations, possible door systems and/or possible positions are displayed to the installer on the mobile terminal. The installer can select a provided door component, installation location, door system and/or position. The display can take place simultaneously or sequentially on the mobile device. The mobile terminal has knowledge of the identifier or the marking and can make an assignment.

There are various ways of communicating to the element to be assigned, in particular to the mobile terminal, the identifier of the installed door component to be assigned. It can be provided that the control unit sends to the mobile terminal the identifier of the installed door component to be assigned. In a first alternative, the identifier or a marking uniquely assigned to the identifier is selected by the installer on the mobile terminal so that the installer can recognize cognitively through a response of the door system to which installed door component the identifier or marking belongs. In a second alternative, the installer themselves acts with the installed door component so that the door arrangement, in particular the mobile terminal and/or the control unit, can recognize which installed door component is to be assigned. In relation to the first alternative in particular, it can be provided that the identifier of the door component or a marking uniquely assigned to the identifier is displayed on the mobile terminal. Receiving a selection of the identifier of the door component or the assigned marking on the mobile terminal preferably causes the door component to output a sensorily perceptible, in particular visual, haptic and/or acoustic sign. Additionally or alternatively, a further door component of the door system causes the output of a sensorily perceptible, in particular visual, haptic and/or acoustic sign, with the sign being assignable to the selected door component. The installer can thus select a door component on the mobile device. This selection causes the selected door component or another door component that can be assigned to the selected door component to output a sensorily perceptible, in particular visual, haptic and/or acoustic sign. This allows the installer to uniquely identify an installed door component.

The output of a sensorily perceptible, in particular a visual, haptic and/or acoustic sign is e.g. provided when a plurality of control units are located in the near-field communication range of the mobile terminal. In this way, the control unit that is located in the door system to be configured can be detected. Additionally or alternatively, the output of a sensorily perceptible, in particular a visual, haptic and/or acoustic sign, can be provided if the door system comprises at least one door component type multiple times. This allows the installer to identify which door component has been installed in which position.

Through the output of the sensorily perceptible, in particular visual, haptic and/or acoustic sign, it is possible in particular for the installer to identify a door component when the door component has already been installed in the provided position.

It is preferably provided that the door component outputs a visual and/or acoustic sign by means of a display element of the door component. The display element is preferably used by the door component during operation of the door system in order to output a visual and/or acoustic sign. For example, a reader should output an acoustic and/or visual sign in the commissioning method according to the disclosure. For this purpose, the reader uses a display element which, during operation, informs a user whether or not access authorization is present. In another example, a hazard detector, in particular a smoke detector, or an emergency button should output an acoustic and/or visual sign in the commissioning method according to the disclosure. For this purpose, the hazard detector or the emergency button uses the same display element with which the hazard detector indicates an alarm during operation of the door system.

It can be provided that the door component outputs a visual and/or acoustic sign in that the door component at least partially carries out an operating step. For example, a motorized door drive can at least partially open or close a door assigned to the door drive in order to output the visual sign.

It can be provided that the door component outputs a haptic sign in that the door component performs an electromechanical action, for example a door opener can unlock a swivel latch or an electromechanical fitting can engage a coupling element. The installer can, through a mechanical action on the door component, e.g. unlocking the door, recognize the haptic sign.

If the installer has input on the mobile terminal that a door component associated with the identifier and/or the marking has to output the sensorily perceptible, in particular the visual, haptic and/or acoustic sign, the control unit with the transmitting and receiving unit receives a corresponding command from the mobile terminal. If the sensorily perceptible, in particular the visual, haptic and/or acoustic sign is to be output by the control unit itself, the control unit then outputs the sensorily perceptible, in particular the visual, haptic and/or acoustic sign. If the in particular visual, haptic and/or acoustic sign is to be output by another door component, the control unit sends a corresponding command via the information technology connection.

The sensorily perceptible, in particular the visual, haptic and/or acoustic sign can be output by the installed door component. An identifier or an assigned marking of an installed door component of the door system can be displayed on the mobile terminal.

The installed door component can be assigned to a provided door component of the door system by means of the sensorily perceptible, in particular visual, haptic or acoustic sign. For this purpose, the identifier or the assigned marking of the selected door components is assigned to a door system by a user input on the mobile terminal. This is in particular the case when a control unit is to be assigned to a door system. For this purpose, the installation locations and/or identifiers of provided door systems are preferably displayed on the mobile terminal, so that the installer can select the installation location and/or identifier and thus select the provided door system. Alternatively, the identifier or the assigned marking of the selected door components is assigned to a provided door component by a user input on the mobile terminal, in particular if a plurality of door components of a door component type and/or security-relevant door components are provided. For this purpose, for example, the positions of provided door components or the provided door components are preferably displayed on the mobile terminal, so that the installer can select the position or the provided door component.

In particular in relation to the second alternative, in which the installer acts with the installed door component to be assigned, the identifier of the installed door component can be identified by the element to be assigned, in particular by the mobile terminal and/or the control unit, based on an action of the installer in relation to the door component. The action of the installer can be detected preferably electrically, particularly preferably electronically, preferably by the installed door component to be assigned. The identification can be carried out in particular by a corresponding signal which in particular is sent at least indirectly from the door component to be assigned to the element to be assigned. The installed door component can then be assigned to the provided door component.

An action on the door component can take place, for example, by way of an actuation in relation to the door component. For this purpose, it can be provided that actuation takes place by actuating a switch or button of the door component, for example an emergency button, or by actuating a switch or button assigned to the door component, for example a manual button of a door drive. An action relating to the door component can take place e.g. by a detection in a monitored region of the door component. For example, the installer is located in a region of a door drive monitored by a sensor or identifies themselves to a detection unit using an access attribute, in particular using a credential.

It is preferably provided that the door component identifies from the action in relation to the door component that the door component has been selected. It can be provided that the action causes the door component to send a corresponding signal or its identifier, in particular to the control unit and/or via the control unit to the mobile terminal. In this way, the door component can be assigned to a provided door component, an installation location, a door system and/or a position, in particular on the mobile terminal. If the control unit itself is to be assigned, then the control unit preferably sends its identifier to the mobile terminal, so that an assignment can take place on the mobile device.

The electronic configuration and/or a software application preferably comprises, as a computer program product for the mobile terminal, an instruction for the installer as to how the action in relation to the door component is to be performed. For example, an instruction is assigned to at least one door component, in particular at least to door components whose door component type is present multiple times in the door system, which the installer can perceive sensorily and which describes the action to be performed. The instruction can preferably be output by the output unit. For example, the installer is informed in a readable manner on the screen and/or by a voice message which action the installer has to perform.

In a further alternative for the method for assigning the identifier of the door components to at least some of the door components or door component types listed in the list of components, in particular the door component that is present multiple times in the door system, a process is predefined for the installer as to the order in which the actions relating to the door components are to be performed. The installer is preferably specified a plurality of instructions and the order of actions to be performed. As a result, the electronic configuration and/or a software application for the mobile terminal predefines the order in which actions relating to a door component are to be performed in order to assign the identifiers of the door components to the provided door components. The assignment then takes place according to the action performed. To do this, the door component for which the action has been performed can send a signal or the identifier.

It may be that in this alternative, no input is required on the mobile terminal. Rather, the electronic configuration and/or the software application predefines the order of the installed door components to be assigned and the associated actions. Alternatively, confirmation can be given by the installer as an input on the mobile terminal. The assignment preferably takes place in the door arrangement, in particular in the control unit or in the mobile terminal. It is preferably provided that at least the identifier of a door component, in particular the identifier of a plurality of or all door components, is stored in the computing unit as belonging to the door system and/or belonging to an installation location.

The identifier of a door component is preferably stored in the computing unit together with at least one further feature of the door component. The electronic storage takes place in particular prior to step a. The other features can be e.g. a production location and/or a production time. With the storage of the identifier of the installed door component for the door system and/or the installation location, the at least one further feature is assigned to the door system and/or the installation location. This makes it possible to trace which door components are installed where during operation.

It can be provided that the control unit is connected to the computing unit in terms of information technology, e.g. via a second bus system. The second bus system can be configured in particular as an IP-enabled bus, e.g. the Ethernet. When the door system is in operation, it can be provided that the control unit knows the operating state of the other door components of the door system and communicates the operating states to the computing unit.

It is preferably provided that a plurality of door components of a door system are connected in terms of information technology. The electronic configuration preferably comprises transmitters and/or receivers of messages that are sent via the information technology connection. For example, it can be specified in the electronic configuration which door component receives a sign-of-life signal from which other door component or which door component receives information about a state from which other door component.

Additionally or alternatively, the electronic configuration can at least partially comprise the processes of operating functions. The processes of operating functions are preferably stored at least partially as firmware in the control unit. An operating function is understood to be a process that always takes place in a timed order during operation and in which a plurality of door components are involved. An operating function preferably comprises a plurality of operating steps.

An operating step can be designed e.g. as a motorized door opening or a motorized door closure. An operating step may be designed, electrically triggered, to close the door by means of a door closer. For example, an operating step may be designed as an electrically performed door unlocking or an electrically performed door locking. The operating step can be designed e.g. as electrically establishing a requirement for manual unlocking and/or locking. An operating step can be designed e.g. as a visual and/or acoustic display of a state of the door system.

For example, the operating function can comprise motorized door opening in connection with the unlocking of at least one locking element. For example, the operating function can comprise motorized door closing in connection with locking of the locking element. For example, the operating function can comprise motorized opening of a first door leaf and subsequent opening of a second door leaf of the same or a different door. Due to the operating functions reproduced as firmware, complicated processes with a plurality of door components are also possible, for example to coordinate an escape route security system with a motorized door drive or an interlock.

Firmware can also be stored in other control devices of the door system, e.g. in a drive controller and/or in an escape route controller to carry out an operating function. The control unit preferably coordinates the control devices of the door system at least in part.

A door component, preferably a bus address, is preferably assigned to a door component, a door component type and/or a position and/or a door component provided in the list of components on site. This can done e.g. by assigning the identifier or the marking to the provided door component. In this case, the assignment can take place by means of the mobile terminal, in particular using the method described, which includes, for example, the output of the sensually perceptible, in particular visual, haptic and/or acoustic sign and/or the action. The control unit and/or the other door components connected to the same bus system thus know which bus address is to be used to address which provided door component. This makes it possible to integrate door components into an operating function only during commissioning without additional wiring.

Additionally or alternatively, the electronic configuration can comprise parameters for operating the door system. The parameters can be e.g. an opening speed of the door, a motorized performance curve of a door drive, a hold-open time of the door, an opening width of the door, an opening angle of the door, a closing speed of the door, an unlocking time of a locking element or an unlocking element, a monitoring time until an alarm is triggered when the door is open or similar.

It may be that the transmitters and/or receivers of messages, the processes of operating functions and/or the parameters can be changed during commissioning. For example, an input option is displayed to the installer on the mobile terminal, in which the installer can make changes.

It may be that the control unit at least partially relays information, e.g. parameters, transmitters and/or receivers of messages and/or firmware, the electronic configuration to other door components, in particular to other control devices. The relaying can take place as early as during the commissioning method or during operation. This can be regarded as step b.

Additionally or alternatively, the electronic configuration can comprise a test process for the door system, in which at least one operating step and/or at least one operating function of the door system is tested for commissioning. This can be regarded as step b.

The test process can be carried out entirely by the control unit. Alternatively, the test process is carried out by the control unit, with the control unit sending instructions and/or information to the mobile terminal and/or receiving it from the mobile terminal, so that the installer is involved in carrying out or accepting the test process.

It is preferably provided that at least a plurality, in particular all, of the door components are connected to a first bus system. A door component is in particular the control unit. At least one further door component is a motorized door drive. At least one further door component is preferably a locking or unlocking element. At least one door drive is particularly preferably connected to a drive controller, an escape route controller of an escape route security system and the control unit to the first bus system.

The control unit preferably assigns bus addresses to the other door components that are connected to the first bus system.

The electrical configuration can be receivable by the control unit from a database with a plurality of permanently predefined electrical configurations. The electronic configuration can preferably be stored in the control unit by, prior to step a., the configuration having been assigned to an identifier of the door system and/or a door system type and/or the installation location. For example, when planning the building, the planned door system has been assigned an in particular unique identifier. The installer can input the unique identifier into the mobile terminal to download the electrical configuration into the control unit. In a further alternative, each electronic configuration is assigned to a door system type. The installer can input the door system type into the mobile terminal to download the electrical configuration into the control unit. In a third alternative, the installation location is linked to the electronic configuration in a database. The installer can input the installation location into the mobile terminal to download the electrical configuration into the control unit.

In a further variant, the control unit or the computing unit assigns an electrical configuration to the door system by means of the installed door component types.

The control unit is preferably connected to a computing unit via a second bus system. The control unit receives the electronic configuration from the computing unit in order to store the configuration in step a.

Additionally or alternatively, the control unit is connected to the mobile terminal via an in particular wireless interface, in particular the transmitting and receiving unit. The control unit receives the electronic configuration from the mobile terminal in order to store the configuration in step a.

It can be provided that the control unit receives at least one key from the mobile terminal in order to communicate in encrypted form in the first bus system and/or in the second bus system. The key is received in particular prior to step a.

The object of the disclosure is also achieved by a door arrangement with a control unit and/or a mobile terminal for carrying out a method according to the disclosure, in particular a method according to one of claims 1 to 15. In particular, the control unit and/or the mobile terminal can here comprise a computer-readable medium on which the electronic configuration and/or a computer program for carrying out the method can be stored. The computer program on the control unit and/or on the mobile terminal can compare e.g. the door components actually installed with the provided door components. The computer program on the control unit can assign e.g. bus addresses to the door components. The computer program on the control unit and/or on the mobile terminal can automatically assign e.g. the identifiers of the door components to the provided door component types. By means of the computer program, the control unit can send e.g. a message to a door component so that the door component outputs an acoustic or visual sign.

The door system comprises at least one further door component, preferably a plurality of further door components. The further door components are preferably connected to the control unit in terms of information technology.

In addition, the door arrangement can comprise a mobile terminal and/or a computing unit. The mobile terminal and/or the computing unit are preferably in an information technology connection with the control unit.

The object of the disclosure is also achieved by a computer program product for carrying out the method according to one of claims 1 to 15. It can be provided within the scope of the disclosure that the computer program product is stored electronically on the control unit. It may be that in order to carry out the method according to the disclosure, a computer program product is stored on the control unit and a computer program product is stored on the mobile terminal. In this case, it is provided in particular that the control unit and the mobile terminal communicate with one another by means of the computer program products. Here, the computer program product can comprise commands to send information to the mobile terminal. The computer program product can comprise commands to send information to the control unit. It is conceivable that the computer program products for carrying out the method according to the disclosure are stored on the control unit, on the mobile terminal and on the computing unit.

### BRIEF DESCRIPTION OF THE DRAWINGS

Further details and advantages of the disclosure will be explained below on the basis of the exemplary embodiments shown in the figures. Technical features with the same function are provided here with identical reference numerals in the figures. They show:

FIG. 1 a first exemplary embodiment of a door system according to the disclosure and a door arrangement according to the disclosure,

FIG. 2 a second exemplary embodiment of a door system according to the disclosure and a door arrangement according to the disclosure,

FIG. 3 a third exemplary embodiment of a door system according to the disclosure and a door arrangement according to the disclosure,

FIG. 4 a basic flow chart of a method according to the disclosure,

FIG. 5 a basic flow chart of a method according to the disclosure,

FIG. 6 a basic flow chart of a method according to the disclosure,

FIG. 7 an alternative method to FIG. 4, and

FIG. 8 an alternative method to FIG. 6

### DETAILED DESCRIPTION OF THE DRAWINGS

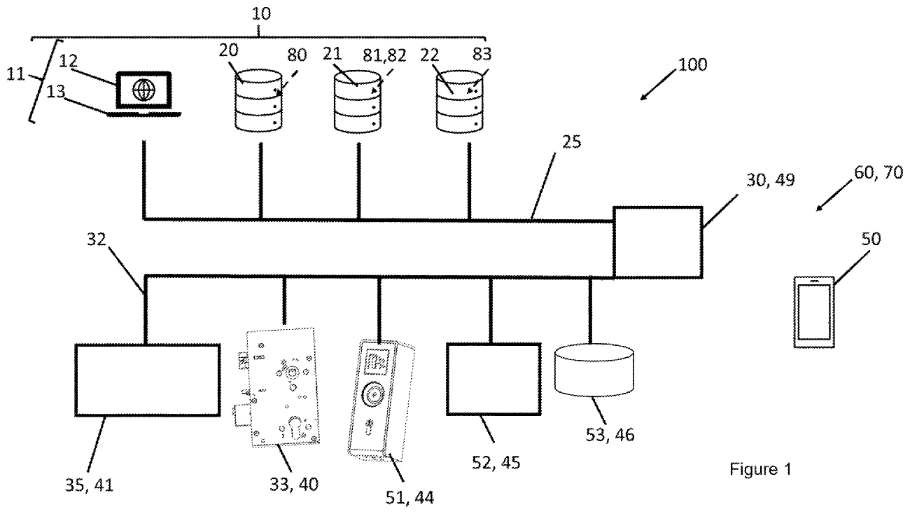

A first exemplary embodiment, a second exemplary embodiment and a third exemplary embodiment of a door system 60, 61, 62 according to the disclosure and a door arrangement 100 according to the disclosure are represented in FIGS. 1 to 3. The door arrangement 100 according to the disclosure comprises a computing unit 10. The computing unit 10 comprises a computing device 11 which is designed as a personal computer. The computing device comprises a screen 12 and a keyboard 13.

The computing unit 10 comprises at least one electronic memory. For example, this can be memory in a cloud. A first database 20, a second database 21 and a third database 22 are stored in the memory. Alternatively and not represented, the first and the second database 20, 21 can be designed as a common database. The second and third database 21, 22 can also be designed as a common database. In a further alternative, the first and the third database 20, 22 can be designed as a common database. In a further database, the first to third database 20, 21, 22 are integrated in a common database.

A configuration system is stored electronically in an electronic memory of the computing unit 10. The configuration system is designed as a computer program product. The configuration system comprises the databases 20, 21, 22.

Different door systems 60, 61, 62 according to the disclosure are represented in FIGS. 1 to 3. The door systems 60, 61, 62 are part of the door arrangement 100 according to the disclosure. The door systems 60, 61, 62 each comprise a control unit 30 as a first door component. The door systems 60, 61, 62 each comprise a first bus system 32, e.g. a CAN bus.

The door systems 60, 61, 62 comprise further door components. The first door system 60 in FIG. 1 comprises, for example, a motorized door drive 35, a motor lock 33, an escape route controller 51 with an emergency button, an electromagnetic door lock 52 and a hazard detector, in particular a smoke detector 53, as further door components. The door components 35, 33, 51, 52, 53 have different functions and functional properties. Thus, the door components 35, 33, 51, 52, 53 belong to different door component types 40, 41, 44, 45, 46.

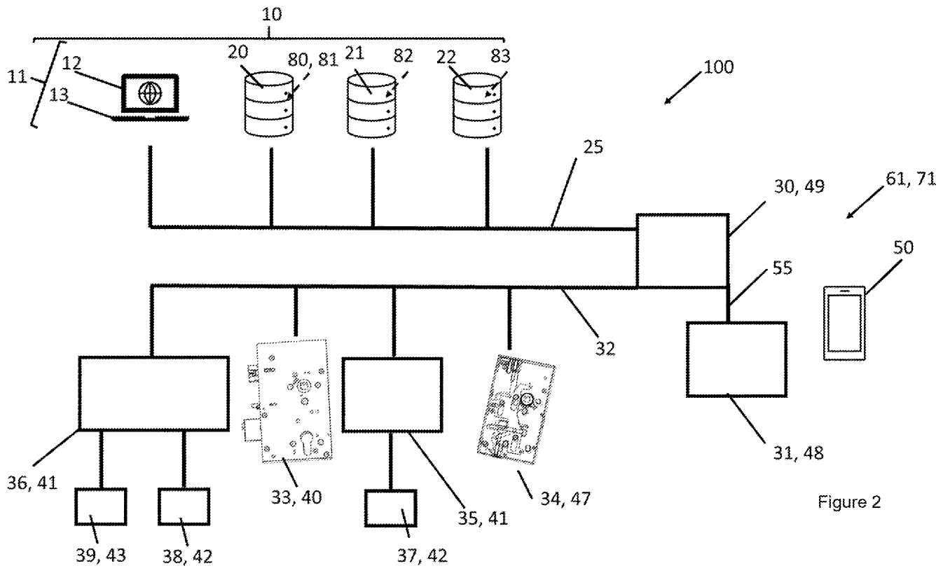

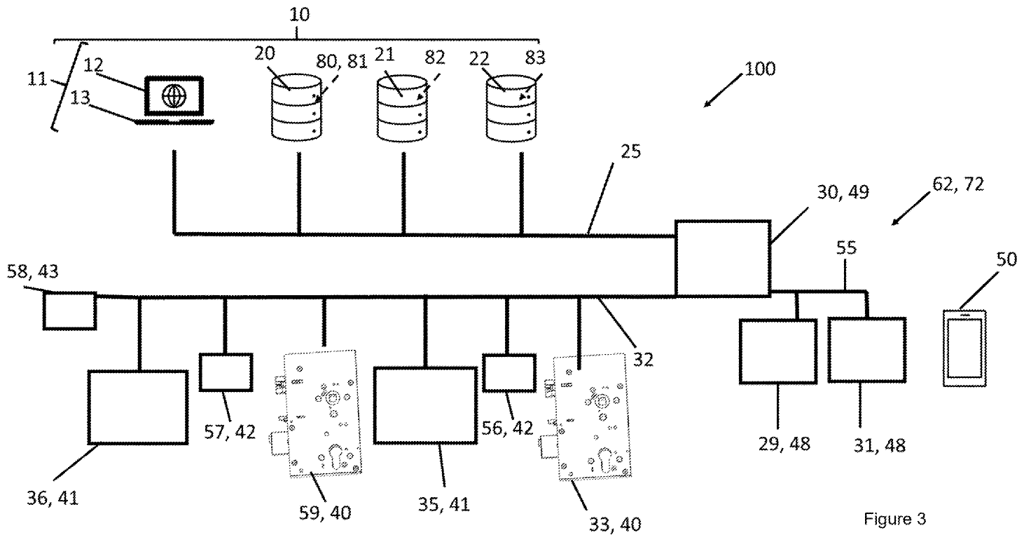

The second door system 61 in FIG. 2 and the third door system 62 in FIG. 3 each comprise a plurality of motorized door drives 35, 36 as door components. The motorized door drives 35, 36 are of identical design and therefore belong to the same door component types 41. Furthermore, the second door system 61 and the third door system 62 comprise a plurality of sensors 37, 38 and 56, 57 as door components. The sensors 37, 38 and 56, 57 are used to detect a person approaching the door leaves. The motorized door drives 35, 36 can then open the door leaves in an order predefined in time as a functional process. Additionally or alternatively, the signals of the sensors 37, 38 or 56, 57 are used to stop the door by means of the door drive 35, 36 in order to avoid injury to the person. The sensors 37, 38 or 56, 57 are of identical design and therefore belong to the same door component types 42.

Furthermore, a program switch 39 or 58 is provided as a door component in each case. A user can use the program switch 39, 58 to determine whether or not the sensors 37, 38 or 56, 57 cause a motorized door opening when a person is detected. The program switch 39, 58 is assigned to a separate door component type 43.

The door drives 35, 36 of the second door system 61 are designed to each be arranged on a door leaf of a double-leaf door. The second door system 61 comprises a motor lock 34 for a passive leaf of the double-leaf door and a motor lock 33 for an active leaf of the double-leaf door. The motor locks 33, 34 are each assigned to their own door component types 40, 47. A further door component of the second door system 61 is designed as a reader 31 as a further door component type 48. In particular, the reader 31 can communicate wirelessly with a card or a mobile telephone in order to receive an access attribute. An access decision is made by the control unit 30.

The door drives 35, 36 of the third door system 62 are designed to each be arranged on a door leaf of an interlock, each with a single-leaf door. The third door system 62 comprises two motor locks 33, 59 for the active leaf. The motor locks each belong to the same door component type 40. The door system 62 also comprises a plurality of readers 29, 31, with one reader 29, 31 each being provided for arrangement on a door of the interlock.

The door components 33, 35, 51, 52, 53 of the first door system 60 are connected to a first bus system 32. Some door components 33, 34, 35, 36 of the second door system 61 are connected to the first bus system 32. Other door components 37, 38, 39 of the second door system 61 are only indirectly connected to the control unit 30 via a door drive 35, 36. The reader 31 is connected via a third bus system 55, e.g. an RS485 bus, to the control unit 30.

The door components 30, 33, 35, 36, 56, 57, 58, 59 of the third door system 62 are connected to the first bus system 32. The components 29, 30, 31 are connected via the third bus system 55.

The control unit 30 comprises a transmitting and receiving unit for wireless near-field communication with a mobile terminal 50. The door arrangement according to the disclosure comprises the mobile terminal 50.

Since the first door system 60, the second door system 61 and the third door system 62 comprises different door components, the door systems 60, 61, 62 correspond to different door system types 70, 71, 72.

A door system 60, 61, 62 is characterized in that each door system 60, 61, 62 comprises a common electronic configuration. The electronic configuration comprises one or a plurality of electronic files in this case. The configuration 82 is designed e.g. as a template and can be stored on the control unit 30. Exactly one configuration for each type of door system 70, 71, 72 is preferably provided.

The electronic configuration 82 each comprises a list of components in which are listed the provided door component types 40, 41, 42, 43, 44, 45, 46, 47, 48, 49 of the door system 60, 61, 62, which are connected to the control unit 30 in terms of information technology. If door component types 40, 41, 42, 43, 44, 45, 46, 47, 48, 49 are present multiple times, the list of components comprises position information. In the exemplary embodiment of FIG. 2, the position information is “door drive for the active leaf”, “door drive for the passive leaf”. In the exemplary embodiment in FIG. 3, the position information is “door drive for the first door”, “door drive for the second door”, “sensor for the first door”, “sensor for the second door”, “motor lock for the first door”, “motor lock for the second door”, “reader for the first door” and “reader for the second door”.

The electronic configuration 82 comprises in each case information about which door components connected to the first or third bus system 32, 55 exchange which messages. Thus, the electronic configuration 82 comprises transmitters and receivers of messages. For example, it is provided that the door drive 36 of the door system 61 or the program switch 58 of the door system 62 reports to the control unit 30 in which operating mode the door system 61, 62 is to be operated. The program switch 58 is thus defined as the transmitter and the control unit 30 as the receiver. One operating mode here is an automatic mode in which, when a person approaches the door, which is detected by the sensor 37, 38, the door drive 35, 36 associated with the sensor opens the door. Another operating mode is manual operation, in which an approach of a person to the door does not lead to a motorized opening of the door. Rather, the person must authenticate themselves at the reader 31 so that the door is opened or can be opened.

As another example, the electronic configuration 82 specifies that when there is a valid access attribute received by the reader 31 for the first door of the door system 62, the control unit 30 causes the motor lock 33 for the first door to be unlocked. For this purpose, the control unit 30 can send a message to a drive controller of the door drive 35 for the first door, which then actuates the motor lock 33 for the first door. Alternatively, the control unit 30 can send a message to the motor lock 33 for the first door. Thus, the control unit 30 is defined as the transmitter and the drive controller or the motor lock 33 as the receiver in the electronic configuration.

The electronic configuration 82 comprises processes of operating functions. In the case of an operating function, a plurality of messages and/or controls must be carried out one after the other in a defined order. The order is stored in the electronic configuration 82 as firmware or as a parameter. For example, in manual mode, a person has authenticated themselves by means of a key switch, which is arranged on the escape route controller 51 in FIG. 1. The escape route controller 51 reports the authentication to the control unit 30 and unlocks the door lock 52. The control unit 30 informs the door drive 35 about the unlocking of the door lock 52 and the duration of the unlocking. The drive controller of the door drive 35 then actuates the motor lock 33 for unlocking and, after the motor lock 33 has been unlocked, opens the door by motor.

The electronic configuration 82 also contains parameters for the door system 60, 61, 62, e.g. an unlocking time of the door lock 52 or a hold-open time for the door drive 35, 36.

The electronic configuration 82 also contains a control program to carry out a test process. In the test process, the operating functions for operation are in particular tested.

A door system 60, 61, 62 each comprises a common control unit 30. The control unit 30 is used to connect to the computing unit 10.

Depending on the door system type 70, 71, 72, a door system 60, 61, 62 can be provided for arrangement on one or on a plurality of doors. In a further exemplary embodiment, not represented, a door system is used, for example, for arrangement on two double-leaf doors arranged one behind the other or on a hotel corridor with four rooms.

It may be that a door arrangement 100 comprises a plurality of door systems 60, 61, 62. The door systems 60, 61, 62 can belong to the same or different door system types 70, 71, 72. The door systems 60, 61, 62 are preferably connected to one another and/or to the computing unit 10 via the second bus system 25.

At the beginning of the commissioning method according to the disclosure, the door components 30, 31, 33, 34, 35, 36, 37, 38, 39, 51, 52, 53, 56, 57, 58, 59 are mechanically arranged on the door and electrically connected to one another, however, the door components 30, 31, 33, 34, 35, 36, 37, 38, 39, 51, 52, 53, 56, 57, 58, 59 are not yet ready to interact as they do in operation.

According to the disclosure, it is provided that an electronic configuration 82 of the door system 60, 61, 62 is stored in each case in the control unit 30 and/or in the mobile terminal 50 during the commissioning method, with which at least one commissioning step is carried out. Since a common configuration 82 is provided for a door system 60, 61, 62, adjustment errors are avoided.

The behavior of the door components 30, 31, 33, 34, 35, 36, 37, 38, 39, 51, 52, 53, 56, 57, 58, 59 is adjusted to one another, in particular when carrying out operating functions. For example, the hold-open time of the door drive 35 is adjusted to an unlocking time of the door lock 52.

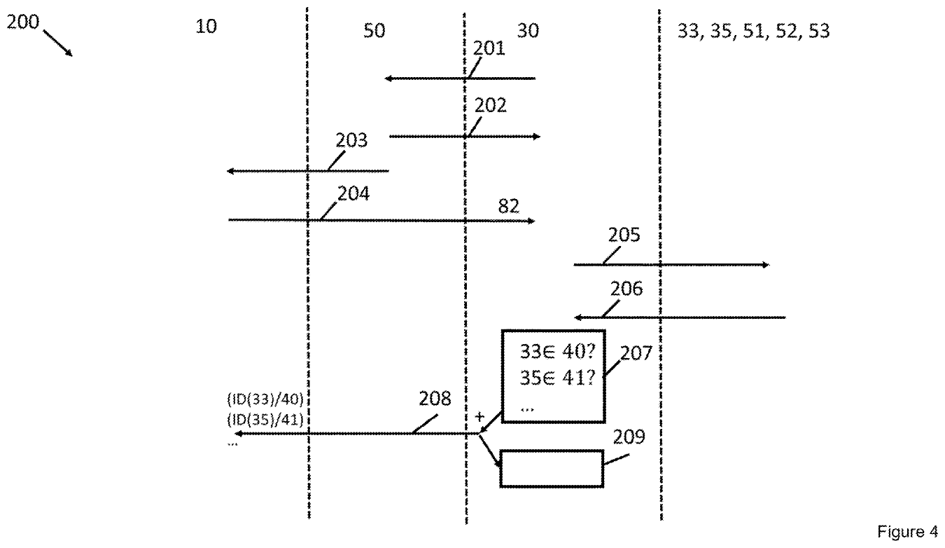

FIG. 4 represents an exemplary embodiment of a commissioning method 200 according to the disclosure. The commissioning method 200 is suitable for the door system 60 of the first exemplary embodiment of FIG. 1. The columns marked by dashed lines symbolize in which unit or between which units the method step takes place. The first column is assigned to the computing unit 10, the second column to the mobile terminal 50, the third column to the control unit 30 and the fourth column to the further door components 33, 35, 51, 52, 53. Communication between the units arranged in the columns takes place via the information technology connection, i.e. the first or second bus system 32, or the wireless near-field communication.

If a plurality of control units 30 for a plurality of door systems 60, 61, 62 are in the near-field communication range of the mobile terminal 50, then the control units 30 send the mobile terminal 50 in each case the identifier of the control unit 30, e.g. “314.567” or “256.397”. The identifiers of the control unit or a marking assigned to the identifier, e.g. “Control unit 1” or “Control unit 2” are displayed to the installer on the mobile terminal 50 in a first method step 201.

The installer can now select an identifier or a marking. The selected control unit 30 then receives the command from the mobile terminal 50 to output a sensorily perceptible, in particular visual, haptic and/or acoustic sign. The selected control unit 30 comprises a light means that now lights up. The lighting time can be predefined. This corresponds to a second method step 202. If the control unit 30 does not comprise a display element, the control unit can cause a further door component 33, 35, 51, 52, 53 of the same door system 60 with a display element to output a sensorily perceptible sign, in particular a visual and/or acoustic sign. For example, a light ring around the emergency button can light up. It is important here that the installer can assign the sign to the control unit 30. Here, a display can be provided on the mobile terminal 30, which allows the installer to assign e.g. “Light ring around the emergency button for control unit 1 lights up”.

The installer can now see at which installation location the control unit 30 is arranged, for example near which hotel or office door. The installer has an in particular digital building plan, in which the information is indicated as to which door system 60 of the door systems 60, 61, 62 and/or which door system type 70, 71, 72 is to be put into operation at the installation location. For this purpose, the unique identifier of the door system 60 e.g. “Door system 156.346” or a door system type, e.g. “Door system type 70” is indicated at the installation location on the building plan. The installer can input the identifier of the door system or the door system type 70 into the mobile terminal 50. Alternatively, the installer can mark the installation location on the digital building plan. The input by the installer is sent to the computing unit 10. This corresponds to a third method step 203.

There are a plurality of options for the fourth method step 204. It may be that the electronic configuration 82 is linked to the identifier of the door system 60 and/or the installation location in the third database 22. In another option, the electronic configuration is linked to the door system type 70 in the second database 21. The control unit 30 can now receive the electronic configuration 82 that suits the door system 60 from the computing unit 10. For this purpose, the control unit 30 can communicate with the computing unit 10 via the second bus system 25, as represented in FIG. 4. In this case, it may be that the control unit 30 first receives a key for encrypting the messages for the first and/or second bus system 25, 32 from the mobile terminal, so that the control unit 30 and the computing unit 10 can communicate with one another in encrypted form. If the second bus system 25 is missing, then the mobile terminal 50 can first receive the electronic configuration 82 and then relay it to the control unit 30. The fourth method step 204 corresponds to step a. of the method 200 according to the disclosure.

In a fifth method step 205, the control unit 30 searches for further door components 33, 35, 51, 52, 53 of the door system 60, which are connected to the first bus system 32. For each further door component 33, 35, 51, 52, 53 found, the control unit 30 allocates a bus address for first bus system 32 in a method step 205.

Each additional door component 33, 35, 51, 52, 53 of the door system 60 connected to the first bus system 32 sends the control unit 30 the identifier of the respective door component 33, 35, 51, 52, 53 and the door system type 40, 41, 44, 45, 46 of the respective door component 33, 35, 51, 52, 53 in a method step 206.

In a method step 207, the control unit 30 compares the door system type 40, 41, 44, 45, 46 of the respective door component 33, 35, 51, 52, 53 with the list of components. This corresponds to a possible step b. of the method.

If the installed door component types 40, 41, 44, 45, 46 match the provided door component types 40, 41, 44, 45, 46, which is represented by a “+” in FIG. 4, the method continues with step 208. In step 208, the control unit 30 30 automatically assigns the identifiers of the door components 30, 33, 35, 51, 52, 53 to provided door component types 40, 41, 44, 45, 46, 49. This corresponds to a possible step b. of the method. Here, the control unit 30 takes into account its own identifier of the control unit 30. Furthermore, a first functional test of the door components 40, 41, 44, 45, 46 is carried out. If the functional test is completed successfully, the control unit 30 sends to the computing unit 10 the assignment of the identifiers of the installed door components 30, 33, 35, 51, 52, 53 to the door component types 40, 41, 44, 45, 46, 49. In FIG. 4, the identifier for this is abbreviated to ID.

The assignment is stored in the third database 22 in the computing unit 10. During the manufacture or purchase of the door components 30, 33, 35, 51, 52, 53, further features of the door components have already been previously stored in the computing unit 10 for the identifiers of the door components 30, 33, 35, 51, 52, 53, in the event of manufacture, these are production location and production date, in the case of purchase, the further features can be comprise e.g. the manufacturing company and the delivery number. In addition, the digital building plan is stored in the computing unit 10, in which the information is indicated as to which door system 60 of the door systems 60, 61, 62 is to be put into operation at the installation location. For this purpose, the identifier of the door system 60 is linked to the installation location on the digital building plan. The information of the identifiers of the door components 30, 33, 35, 51, 52, 53 is now linked to the identifier of the door system 60 and/or the installation location. This allows the other features of the door components 30, 33, 35, 51, 52, 53 to be linked to the installation location.

In a step 209, the control unit now sends information to the other door components 33, 35, 51. The information can comprise transmitters and receivers of messages, the processes of operating functions and/or the parameters. The test process can then follow. This corresponds to a possible step b. of the method.

Since the door components 33, 35, 51, 52, 53 report the respective door component type 40, 41, 44, 45, 46 to control unit 30 with the bus addresses just allocated in the method step 206, the control unit 30 knows which door component 33, 35, 51, 52, 53 in which operating step of which operating function is to be actuated with which bus address. Since the operating functions are available as firmware and the door components 33, 35, 51, 52, 53 are connected via the first bus system 32, complex operating functions can also be implemented.

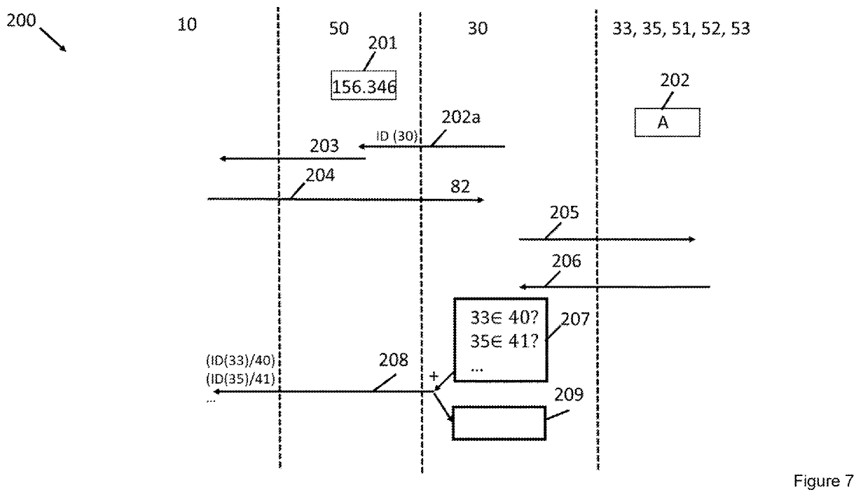

An alternative commissioning method 200 for the door system 60 of the first exemplary embodiment is represented in FIG. 7. Unless described below, the commissioning method of FIG. 7 corresponds to that of FIG. 4.

Steps 205 and 206 of the method of FIG. 4 are carried out as steps 201 and 202 at the start of the method of FIG. 7. That is to say that in a first method step 201, the control unit 30 searches for further door components 33, 35, 51, 52, 53 of the door system 60, which are connected to the first bus system 32. For each further door component 33, 35, 51, 52, 53 found, the control unit 30 allocates a bus address for first bus system 32 in a method step 201.

Each additional door component 33, 35, 51, 52, 53 of the door system 60 connected to the first bus system 32 sends the control unit 30 the identifier of the respective door component 33, 35, 51, 52, 53 and the door component type 40, 41, 44, 45, 46 of the respective door component 33, 35, 51, 52, 53 in a second method step 202.

The installer has an in particular digital building plan, in which the information is indicated as to which door system 60 of the door systems 60, 61, 62 and/or which door system types 70, 71, 72 is to be put into operation at the installation location. For this purpose, the unique identifier of each door system 60 is indicated at the installation location on the building plan, e.g. “Door system 156.346” or a door system type, e.g. “Door system type 70”. If the installer has newly installed a plurality of door systems 60, 61, 62, then in a method step 201 the installer can input the identifier of a newly installed door system 60 into the mobile terminal 50 or select it on the mobile terminal. The newly installed door systems can be displayed here for selection. Alternatively, the installer can input or select the installation location on the mobile terminal 50. This corresponds to a third method step 203.

The screen of the mobile terminal 50 now shows that the input door system 60 comprises a control unit 30 and that it can be identified by an action A described on the screen. This method step may be optional and only displayed to inexperienced installers. For example, it is possible that the installer can set that this information is no longer displayed.

For example, it is provided as an action that the installer presses a button on the control unit 30 or is located at a short distance from the control unit 30 with the mobile terminal 50. Alternatively, the action can also correspond to an action on a door component 33, 35, 51, 53 connected to the control unit 30. For example, the action can correspond to a mechanical actuation of the motor lock 33, a triggering of the hazard detector 53 or an actuation of the emergency button of the escape route security system 51.

In a fourth method step 204, the installer performs the action A on the door component 30, 33, 35, 51, 53 that is indicated to the installer or that known to the installer. The control unit 30 recognizes the action. Either the control unit 30 recognizes the action because the action has already been performed on the control unit itself. Alternatively, the actuated door component 33, 35, 51, 53 reports the actuation to control unit 30. On the basis of the reporting door component and/or on the basis of the reported action, the control unit 30 recognizes that control unit 30 has been selected. After recognizing the action, the control unit 30 sends the identifier of the control unit 30 to the mobile terminal in a method step 205.

In a method step 206, the mobile terminal 50 sends to the computing unit 10 the assignment of the identifier of the control unit 30 to the door system 60.

The control unit 30 can then receive the electronic configuration 82 in a method step 206. This corresponds to the method step a. The options for how the control unit 30 can receive the electronic configuration 82 correspond to the options listed for step 204 of FIG. 4.

The method steps 207 to 209 of FIG. 7 correspond to the method steps 207 to 209 described for FIG. 4.

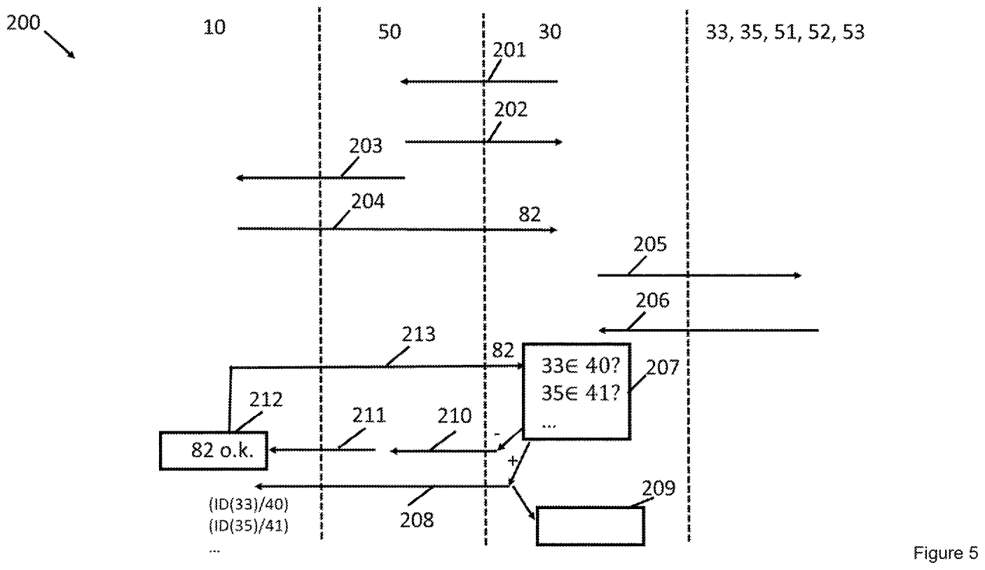

Alternatively and not represented, the mobile terminal 50 can receive the electronic configuration 82 in method step 206. The control unit 30 sends the door component types to the mobile terminal 50, which makes the assignment and then sends it to the control unit 30. The commissioning method 200 for the door system 60 of the first exemplary embodiment of FIG. 1 is represented again in FIG. 5. In this case, reference is made to the description of FIG. 4. In contrast to the method of FIG. 4, in method step 207 the installed door component types 40, 41, 42, 43, 44, 45, 46, 47 do not match the list of components, which is indicated in FIG. 5 by a “−”. As a result, in the embodiment variant represented in FIG. 5, the commissioning method is always interrupted with the stored configuration. This is specified by the firmware on the control unit 30. For example, instead of the motor lock 33, a mortise lock without a motor has been installed.

In a step 210, the installer receives a corresponding message on the mobile terminal 50. The installer can decide, or present to a building planner for a decision, whether to continue the commissioning method with the installed door components, or to install the missing door component first, or to replace the incorrect door component. If the installer or the building planner would like to continue the method with the installed door components, the installer can request the download of a suitable configuration 82 for the installed door components 35, 51, 52, 53 in a step 211. For this purpose, the control unit 30 or the mobile terminal 50 can inform the computing unit 10 of the door components actually installed 35, 51, 52, 53. It may be that the configuration system makes a suggestion to the installer or the building planner as to which door system type 70, 71, 72 is now available and which configuration 82 is to be stored on the control unit 30 accordingly. In a step 212, the alternative configuration 82 is confirmed, in particular by a building planner on the computing device 11.

In a variant of the method 200, only the building planner has the authority to decide whether or not the commissioning method should be continued with the missing or incorrect door component and/or which door system type 70, 71, 72 corresponds to the installed door components 35, 51, 52, 53 or whether the commissioning method should be continued with the configuration 82 suggested by the configuration system.

If an alternative configuration 82 could be found, then the alternative configuration is stored in a step 213 on the control unit 30 and the method continues with step 207. If the comparison in step 207 is positive, steps 208 and 209 follow, as described for FIG. 4.

An alternative to the process in FIG. 5 is conceivable: If the installed door component types 40, 41, 42, 43, 44, 45, 46, 47 do not match the list of components in method step 207, then in one embodiment variant the installer receives a corresponding message on the mobile terminal 50 in a step 211. However, the installer and/or building planner is free to continue the commissioning method 200 with the stored configuration 82. This can be provided if e.g. a newer version of a door component has been installed. The configuration system or the control unit 30 may suggest to the installer or building planner to put the door system 60 into operation with a limited range of door components. It may be that only the building planner has authority to continue the commissioning method with the stored configuration. In this embodiment variant, it can also be provided that the commissioning method is discontinued with the stored configuration for specified deviations.

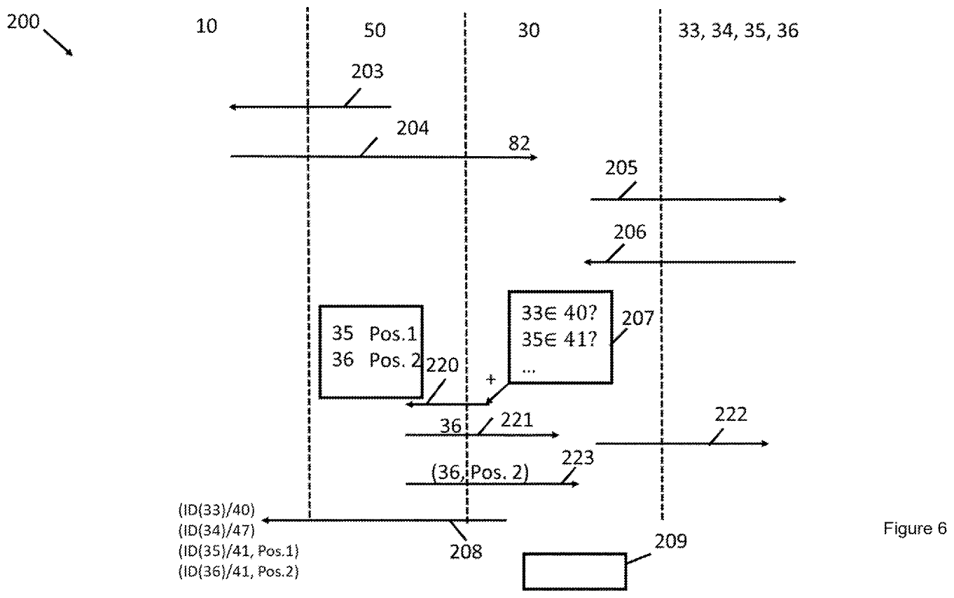

FIG. 6 represents an exemplary embodiment of a commissioning method 200 according to the disclosure. The commissioning method 200 is suitable for the door systems 61, 62 of the second and third exemplary embodiment of FIGS. 2 and 3. If steps are identical or analogous to the steps in FIG. 4 or 5, reference is made to the description of FIGS. 4 and 5. It may also be the case that in the method 200 of FIG. 6, a plurality of control units are located in communication range of the mobile terminal 50 and that steps 201 and 202 of FIG. 4 therefore take place. However, it is assumed for example that only one control unit 30 is located within communication range, so that the method 200 of FIG. 6 starts with steps 203 to 206 of FIG. 4.

In the case of the door system 61 of FIG. 2, in step 205 only those door components 33, 34, 35, 36, which are connected to the first bus system 32, are assigned here to a bus address. In step 206, only the door components 33, 34, 35, 36 connected to the first bus system 32 send the identifier of the respective door component 33, 34, 35, 36 and the door system type 40, 41, 47 of the respective door component 33, 34, 35, 36. In a method step 207, the control unit 30 compares the door system type, 40, 41, 47 of the respective door component 33, 34, 35, 36 with the list of components. If the list of components does not match the installed door component types and their number, the method continues with step 210 (not represented), as in FIG. 5.

If the installed door component types match the provided door component types, which is represented by a “+” in FIG. 6, the door components 35, 36 present multiple times, which are connected to the first bus system 32, are now to be assigned to a position. In the door system 61, they are the door drives 35, 36, of which a door drive 35 is in the position “on the passive leaf” and a door drive 36 is in the position “on the active leaf”. Therefore, in the next step 220, the identifiers of the door drives 35, 36 or a marking assigned to the identifier, e.g. “Door drive 1” or “Door drive 2” is displayed to the installer on the mobile terminal 50 after this information has been sent from the control unit 30 to the mobile terminal 50. In addition, at least one of the positions of the door drives 35, 36 “on the passive leaf” and “on the active leaf” is displayed to the installer on the mobile terminal 50. This is represented schematically in FIG. 6 as “Pos. 1” and “Pos. 2”.

The installer can now select an identifier or a marking, e.g. for the door drive 36. In a step 221, the selected control unit 30 then receives the command from the mobile terminal 50 that the selected door drive 36 has to output a sensorily perceptible, in particular visual and/or acoustic, sign. The control unit 30 informs the door drive 36 of the command. In a step 222, the door drive 36 then outputs a visual and/or acoustic sign. For this purpose, the door drive 36 can set a sign by way of means that the door drive 36 also uses during operation. For example, the door drive 36 can jolt the door or move the door a little.

The installer can now see the position at which the selected door drive 36 is arranged, in this case on the active leaf. On the mobile terminal 50, the installer can input the correct position. The mobile terminal 50 transmits the correct position “on the active leaf” (Pos. 2) and the identifier of the selected door drive 36 to the control unit 30 in a step 223. Optionally, 221 to 223 can be repeated for the other door drive. Alternatively, the control unit can assign the door drive 35 to the passive leaf according to the principle of exclusion.

In the next step 208, the assignments of the identifier of the door components 33, 34, 35, 36 to the door component types 40, 41, 47 and their position “Pos” are then sent from the control unit 30 to the computing unit 10. This assignment also results if the provided door components are e.g. numbered motor lock on the active leaf, motor lock on the passive leaf, door drive on the active leaf and door drive on the passive leaf and the identifiers are made to the numbered door components provided. As a result, there is an indirect assignment to a door component type and/or a position. An assignment of this type “identifier 1/door component 1”, “identifier 2/door component 2” can be sent to the computing unit 10 in step 208.

In a step 209, the control unit now sends information to the other door components 33, 34, 35, 36. The information can comprise transmitters and receivers of messages, the processes of operating functions and/or the parameters. This corresponds to a possible step b. of the method. The test process can then follow. This corresponds to a possible step b. of the method.

In an alternative that is not represented, the list of components comprises the door components 37, 38, 39 that are not connected to the first bus system. In step 206, the control unit 30 is informed of the presence of those door components 37, 38, 39 which are not connected to the first bus system 32. The door drives 35, 36 connected to the door components 37, 38, 39 report the presence of the door components 37, 38, 39 in this case. For this purpose, the door drives 35, 36 have previously verified whether the door components 37, 38, 39 are connected. In a further alternative, the control unit 30 sends a request to the mobile terminal 50 so that the installer confirms the presence of the door components 37, 38, 39 via an input on the mobile terminal 50 or performs an action that allows the door drive 35, 36 to determine the presence of the door components 37, 38, 39.

A process similar to that described for the door system 61 results for the door system 62 from FIG. 3. However, since there are three door component types 40, 41, 42 present multiple times, steps 221, 222 are carried out for each of the door components 34, 35, 36, 56, 57, 59. Thus, the door components 34, 35, 36, 56, 57, 59 are assigned to the door component types with the position information “door drive for the first door”, “door drive for the second door”, “sensor for the first door”, “sensor for the second door”, “motor lock for the first door”, “motor lock for the second door”.

It is not represented in FIG. 6 that the following step is carried out for the second or third door system 61, 62 and for the third bus system 55 instead of step 205: The control unit 30 searches in the bus system 55 for existing bus addresses. For each bus address found, the at least one door component 29, 31 sends the control unit 30 the identifier of the respective door component 29 or 31 and the door system type 48 in a method step 206.

In a method step 207, the control unit 30 compares the door system type 48 of the respective at least one door component 29, 31 with the list of components.

In step 208, the identifier of the door components 29, 31 together with the door component type 48 is also transmitted to the computing unit 10. Steps 220, 221, 222, 223 must also be carried out for the third door system 62. In step 208, the identifiers of the readers 29, 31 are transmitted together with the door component type 48 and the position “at the first door” or “at the second door”.

Since in method step 206 the door components 33, 34, 35, 36, 56, 57, 58, 59 with the bus addresses just allocated report the respective door component type 40, 41, 42 43, 47 to the control unit 30 and in method step 223, an assignment takes place to a position, the control unit 30 knows which door component 33, 34, 35, 36, 56, 57, 58, 59 is to be actuated in which operating step of which operating function with which bus address. Since the operating functions are available as firmware and the door components 33, 35, 51, 52, 53 are connected via the first bus system 32, complex operating functions can also be implemented. Since the door components 29, 31 of the third bus system 55 are also assigned to a position “at the first door” and “at the second door” in a step 223, the readers 29, 31 can be integrated into the operating functions. The control unit 30 knows which bus address is to be used to address which reader 29, 31. The control unit 30 knows which door drive, which motor lock, which sensor and which reader are arranged on which door and therefore interact functionally.

The different door system types 70, 71, 72 can be assigned functional and/or technical properties and/or circuit diagrams in the first database.

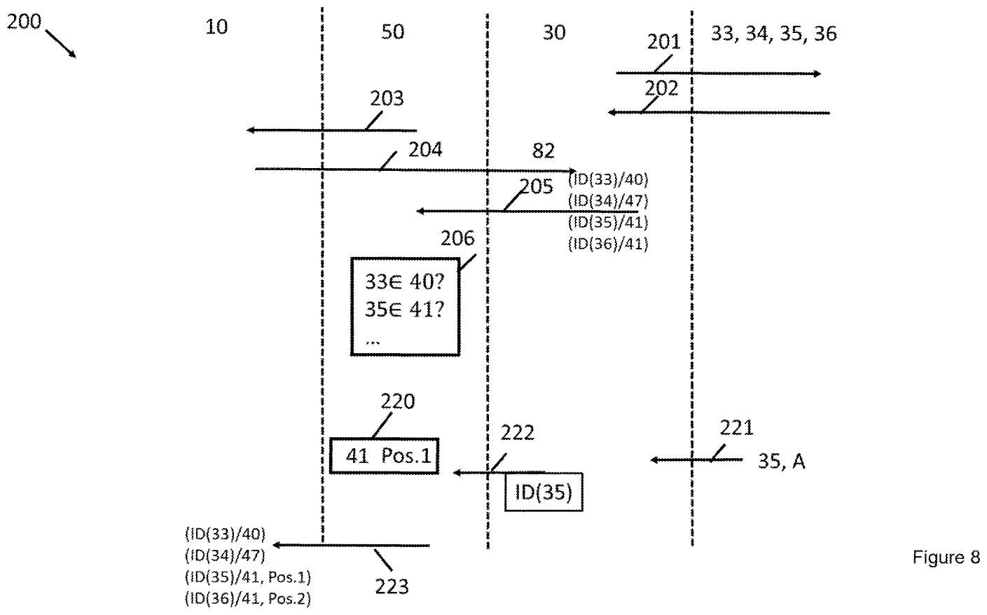

An alternative to the commissioning method 200 from FIG. 6 is shown in FIG. 8 as an example of the second exemplary embodiment of a door system 61 of FIG. 2.

Steps 201 to 205 from the exemplary embodiment of FIG. 7 can first be carried out if a plurality of control units 30 are located in the communication range of the mobile terminal 50. If there is only one control unit 30 in the communication range of the mobile terminal 50, steps 203 and 204 can be omitted. That is to say that first, in method steps 201 and 202, the bus addresses are allocated by control unit 30 and the door component types 40, 41, 47 and the identifiers of the installed door components 33, 34, 35, 36 are reported to the control unit 30. In a step 205, the control unit 30 reports the identifier of the control unit 30 to the mobile terminal 50.

The installation location, the door system 61 or the door system type 71 is available to the mobile terminal 50 through input on the mobile terminal 50. This is reported to the computing unit in a method step 203. The mobile terminal 50 receives the list of components from computing unit 10 in a method step 204. This corresponds to method step a. In a method step 205, the control unit 30 reports the door component types 40, 41, 47 and the identifiers of the installed door components 33, 34, 35, 36 to the mobile terminal 50. By comparing the provided door components in the list of components with the reported door component types 40, 41, 47, the mobile terminal 50 can determine whether the correct door component types 40, 41, 47 are installed. If a door component type 40, 41, 47 is only present once, the mobile terminal 50 can automatically assign the identifier of the installed door component 33, 34, 35, 36 to the provided door component of the list of components in a method step 206. This corresponds to method step b. If there are a plurality of door components of the same door component type 40, 41, 47 in the list of components or if security-relevant door components are provided, then these door components are displayed on the screen of the mobile terminal 50.

In this case, the door component type door drive is provided multiple times. The door components 35, 36 of this door component type 41 are listed one after the other or together on the screen of the mobile terminal 50. It is described for each such door component 35, 36, the position at which the door component 35, 36 is located. Optionally, an instruction as to what action the installer must take for assignment can be listed on the screen for each door component 35, 36. For example, the installer has to stand in the detection range of the associated sensor 37, 38. Alternatively, the installer must press a button on the door drive 35, 36 or unlock a motor lock 33, 34 associated with the door drive 35, 36.

In a method step 220, the installer selects, for example, the provided door component 35 and thus indirectly position 1. The installer then performs action A provided for the provided door component 35 on the installed door component 35. The installed door component 35 reports the action to the control unit 30 in that the door component 35 sends a corresponding signal, in particular a corresponding bus telegram, in a method step 221. In a step 222, the control unit 30 sends to the mobile terminal 50 that the door component 35 has sent a signal with the identifier and/or the bus address. The mobile terminal 50 can now assign the provided door component 35, which contains position 1, to the known bus address and/or the identifier of that door drive 35 which has just sent the corresponding signal.

Steps 220, 221, 222 can now be repeated with the door component 36. Alternatively, the mobile terminal 50 can make this final assignment using an exclusion method.

Alternatively, all of the door components or all of the door components in an information technology connection with the control unit 30 can be displayed on the mobile terminal and can be assigned by an action by the installer.

After the mobile terminal 50 has made the assignment, the mobile terminal 50 sends the assignment to computing unit 10 in a method step 223. The electronic configuration 82 is supplemented accordingly in the computing unit 10. Then, in a method step, the electronic configuration or parts of the electronic configuration, in particular transmitters and/or receivers of messages, processes of operating functions, parameters for operating the door system, a test process for the door system, is sent to the control unit 30, if necessary via mobile terminal 50. This can also be regarded as method step a.

In a step 209, the control unit now sends information to the other door components 33, 34, 35, 36 from the electronic configuration. The information can correspond to transmitters and receivers of messages, the processes of operating functions and/or the parameters. This corresponds to method step b. The test process can then follow. This can also or alternatively be regarded as method step b.

In a further alternative that is not represented, the mobile terminal 50 redefines the order of assignment. This means that the installer does not have to select the door component in method step 220.

In a further alternative to the method of FIG. 8, the assignment is not carried out by an action on a door component. Rather, the control unit 30 sends the installed door components to the mobile terminal 50. The installer selects the installed door component. Proceeding from the mobile terminal 50 via the control unit 30, the selected door component is prompted to output a visual or acoustic sign. The installer can then identify the position of the selected door component and input it into the mobile terminal 50, which then assigns the installed door components to the provided door component. This corresponds to method step b. The assignment is transferred from the mobile terminal 50 to the control unit 30. Parameters, operating functions and the test process are also transferred to the control unit 30 from the mobile terminal. The test process is then carried out by the control unit 30.

In all methods, it may be that the commissioning step b. is carried out by being implemented as firmware by means of the control unit 30 and/or the mobile terminal 50. Furthermore, it may be that the commissioning step b. requires an electronic communication between the mobile terminal 50 and the control unit 30. Thus, the commissioning step is carried out by being implemented in firmware or software on the devices 30, 50. This applies to steps 220, 221 and 223, with an input into the mobile terminal 50 being partially required. Step 222 is carried out within the door system 60, 61, 62 by the control unit 30 and a further door component.

The door component designated as “installed” does not necessarily have to be already installed on the wall or door. It is sufficient if the door component is already intended for the corresponding position or the corresponding installation location.

1. A method for commissioning a door system, wherein the door system has a plurality of door components, wherein at least one door component is configured as a control unit, wherein the method includes the following steps:
a. storing an electronic configuration of the door system in the control unit and/or in a mobile terminal, and
b. carrying out at least one commissioning step by the electronic configuration
wherein the electronic configuration is a list of components at least regarding the provided door component types of the door system and/or regarding provided door components of the door system, wherein the control unit and/or the mobile terminal at least have knowledge of the installed door component types or the installed door components which have an information technology connection to the control unit, wherein the control unit and/or the mobile terminal compare the list of components with the door components actually installed and/or the door component types actually installed.

2. (canceled)

3. The method according to claim 1, wherein a specification is stored electronically as to how the commissioning method is to be continued if the list of components deviates from the installed door component types or the installed door components,
wherein the specification of how to continue the commissioning method corresponds to one of the following options depending on the type of deviation:
the start-up of an operation of the door system is electronically prevented

4. The method according to claim 3, wherein if the continuation of the commissioning method is prevented due to the deviation, a door system type is changed to an alternative door system type that corresponds to the installed door component types or the installed door components, wherein step a. is repeated with the electronic configuration of the alternative door system type, wherein each door system type is assigned to an electronic configuration.

5. The method according to claim 1, wherein the door components, of the door system each comprise an identifier, wherein the identifier of a plurality of or all door components is stored in a computing unit as belonging to the door system.

6. The method according to claim 1, wherein, if only one door component of a door component type is present in the door system, the installed door component, is automatically assigned to the door component type.

7. The method according to claim 1, wherein an installed door component is assigned to a provided door component by an input on the mobile terminal, for which at least one position of provided door components or the provided door components are displayed on the mobile terminal, so that the installer can select or confirm the position of the provided door component or the provided door component.

8. The method according to claim 1, wherein an identifier of an installed door component of the door system is at least partially displayed on a mobile terminal, wherein a sensorily perceptible, sign can be output so as to be assignable by the installed door component or to the installed door components, wherein the installed door component is assigned to one of the provided door components of the door system by the sensorily perceptible, sign, by the identifier or a marking of the selected door components being assigned to a door system or a provided door component of the door system by receiving a user input on the mobile terminal.

9. The method according to claim 6, wherein the mobile terminal and/or the control unit, based on an electronically detectable action by the installer in relation to the installed door component, identifies the identifier of the installed door component and the installed door component is assigned to the provided door component.

10. The method according to claim 1, wherein the identifier of a door component together with other features of the door components is stored in prior to step a., in the computing unit designed as a cloud, wherein by storing the identifier of the installed door component with the door system and/or with an installation location, the other features are assigned to the door system and/or the installation location.

11. The method according to claim 1, wherein the electronic configuration of the door system comprises at least one of the following data:
processes of operating functions,
parameters for operating the door system
a test process for the door system, in which at least one operating step and/or one operating function of the door system is tested for commissioning.

12. The method according to claim 1, wherein at least a plurality of the door components are connected to a first bus system, wherein the control unit (30) assigns bus addresses to the other door components, which are connected to the first bus system.

13. The method according to claim 1, wherein the electrical configuration is received by the control unit and/or the mobile terminal from a database with a plurality of permanently specified electrical configurations, wherein the electronic configuration can be stored in the control unit and/or the mobile terminal by, prior to step a., the configuration having been assigned to an identifier of the door system and/or a door system type and/or an installation location or an electrical configuration being assigned by the installed door component types.

14. The method according to claim 1, wherein the control unit is connected to a computing unit via a second bus system and/or is connected to a mobile terminal via a wireless interface, wherein the control unit receives the electronic configuration from the computing unit or from the mobile terminal in order to store the configuration in step a.

15. The method according to claim 1, wherein prior to step a., at least one key is received by the control unit from the mobile terminal in order to communicate in encrypted form in a first bus system and/or in a second bus system.

16. A door arrangement with a door system and a mobile terminal and/or a computing unit for carrying out the method according to claim 1.

17. A computer program product(s) for carrying out the method according to claim 1.
